(19) United States
(12) Patent Application Publication
(10) Pub. No.: US 2026/0261606 A1
(43) Pub. Date: Sep. 3, 2026

(54) COMMUNICATION METHOD, APPARATUS AND DEVICE, AND STORAGE MEDIUM, CHIP, PRODUCT AND PROGRAM

(71) Applicant: GUANGDONG OPPO MOBILE TELECOMMUNICATIONS CORP., LTD., Dongguan, Guangdong (CN)

(72) Inventors: Yali GUO, Dongguan, Guangdong (CN); Boren GUO, Dongguan, Guangdong (CN)

(73) Assignee: GUANGDONG OPPO MOBILE TELECOMMUNICATIONS CORP., LTD., Dongguan, Guangdong (CN)

(21) Appl. No.: 19/482,562

(22) PCT Filed: Jul. 21, 2022
(86) PCT No.: PCT/CN2022/107168

§ 371 Date: Nov. 7, 2025

(51) Int. Cl. H04L 69/22

(52) U.S. Cl. CPC H04L 69/22

(57) ABSTRACT

Provided is a communication method, apparatus and device, and a storage medium, a chip, a product and a program. In the method, on the basis of order information in a target data packet, a user plane network element adding a first protocol packet header to the target data packet, wherein the first protocol packet header includes first information that can be read by an access network device, the first information being used for indicating a sequence of the target data packet in a data set to which the target data packet belongs: and the user plane network element sending, to the access network device, the target data packet, to which the first protocol packet header is added.

### CROSS REFERENCE TO RELATED APPLICATION

This is a National Stage Application of International Application No. PCT/CN2022/107168 filed on Jul. 21, 2022, and entitled “COMMUNICATION METHOD, APPARATUS AND DEVICE, AND STORAGE MEDIUM, CHIP, PRODUCT AND PROGRAM”, the disclosure of which is incorporated therein by reference in its entirety.

### TECHNICAL FIELD

Embodiments of the present disclosure relate to the field of mobile communication technologies, and specifically to a communication method, apparatus and device, a storage medium, a chip, a product, and a program.

### BACKGROUND

When an access network device receives multiple data packets sent by a user plane network element, the access network device sends the multiple data packets to a terminal device. The access network device needs to perform transmission control on the sending of the multiple data packets, which, however, is not considered in the related art.

### SUMMARY

An embodiment of the present disclosure provides a communication method. The method includes the following operations. A user plane network element adds a first protocol packet header to a target data packet based on sequence information in the target data packet; the first protocol packet header includes first information readable by an access network device, and the first information indicates a sequence of the target data packet in a data set to which the target data packet belongs. The user plane network element sends the target data packet with the added first protocol packet header to the access network device.

An embodiment of the present disclosure provides a user plane network element, including a processor and a memory. The memory stores a computer program executable by the processor. The processor, when executing the program, is configured to add a first protocol packet header to a target data packet based on sequence information in the target data packet; the first protocol packet header includes first information readable by an access network device, and the first information indicates a sequence of the target data packet in a data set to which the target data packet belongs; and send the target data packet with the added first protocol packet header to the access network device.

An embodiment of the present disclosure provides an access network device. The access network device includes a processor and a memory. The memory stores a computer program executable by the processor. The processor, when executing the program, is configured to receive a target data packet sent by a user plane network element; a first protocol packet header of the target data packet comprises first information, and the first information indicates a sequence of the target data packet in a data set to which the target data packet belongs; and read the first information from the first protocol packet header in the target data packet.

### BRIEF DESCRIPTION OF THE DRAWINGS

The accompanying drawings described herein are intended to provide a further understanding of the present disclosure and constitute a part of the present disclosure, and the schematic embodiments of the present disclosure and the description thereof are intended to explain the present disclosure n, and do not constitute an undue limitation of the present disclosure. In the drawings:

FIG. 1 is a schematic diagram of an application scenario according to an embodiment of the present disclosure.

FIG. 2 is a schematic diagram of a system architecture based on a reference point presentation mode according to an embodiment of the present disclosure.

FIG. 3 is a schematic diagram of a system architecture based on a service-oriented presentation mode according to an embodiment of the present disclosure.

FIG. 4 is a schematic flowchart of a communication method according to an embodiment of the present disclosure.

FIG. 5 is a schematic flowchart of another communication method according to an embodiment of the present disclosure.

FIG. 6 is a schematic flowchart of yet another communication method according to an embodiment of the present disclosure.

FIG. 7 is a schematic flowchart of still another communication method according to an embodiment of the present disclosure.

FIG. 8 is a schematic structural diagram of a communication apparatus according to an embodiment of the present disclosure.

FIG. 9 is a schematic structural diagram of another communication apparatus according to an embodiment of the present disclosure.

FIG. 10 is a schematic structural diagram of yet another communication apparatus according to an embodiment of the present disclosure.

FIG. 11 is a schematic structural diagram of a communication device according to an embodiment of the present disclosure.

FIG. 12 is a schematic structural diagram of a chip according to an embodiment of the present disclosure.

### DETAILED DESCRIPTION

Hereinafter, the technical solutions in the embodiments of the present disclosure will be described with reference to the accompanying drawings in the embodiments of the present disclosure, and it is obvious that the described embodiments are part of the embodiments of the present disclosure, but not all the embodiments. Based on the embodiments in the present disclosure, all other embodiments obtained by those skilled in the art without creative work fall within the scope of protection of the present disclosure.

The technical solutions described in the embodiments of the present disclosure may be arbitrarily combined as long as there is no conflict. In the description of the present disclosure, “a plurality” means two or more unless specifically defined otherwise.

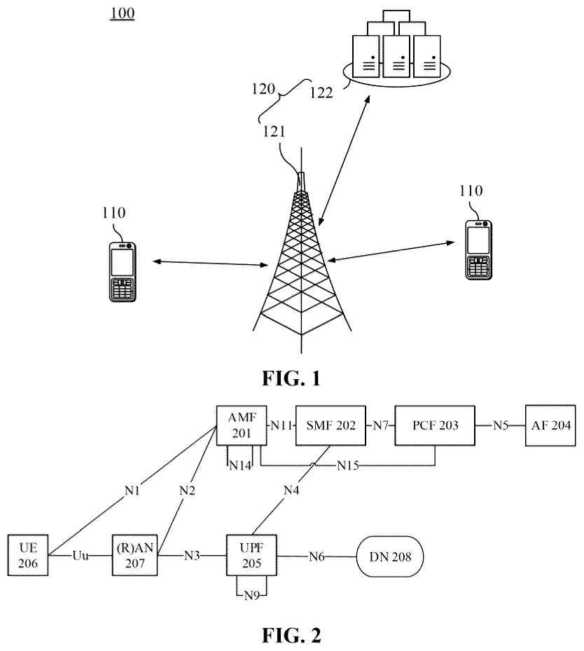

FIG. 1 is a schematic diagram of an application scenario according to an embodiment of the present disclosure. As shown in FIG. 1, the communication system 100 may include a terminal device 110 and a network device 120. The network device 120 may communicate with the terminal device 110 through an air interface. Multi-service transmission is supported between the terminal device 110 and the network device 120.

It should be understood that the embodiment of the present disclosure is only illustrated with reference to the communication system 100, but the embodiment of the present disclosure is not limited thereto. That is, the technical solution of the embodiment of the present disclosure can be applied to various communication systems, such as a Long Term Evolution (LTE) system, an LTE Time Division Duplex (TDD), a Universal Mobile Telecommunication System (UMTS), an Internet of Things (IoT) system, and a Narrow Band Internet of Things (NB-IoT) Systems, an enhanced Machine-Type Communications (eMTC) system, a 5th generation (5G) communication system (also referred to as New Radio (NR) communication system), or a future communication system (e.g. 6G, 7G communication system), etc.

The network device 120 in the embodiment of the present disclosure may include an access network device 121 and/or a core network device 122. An access network device may provide communication coverage for a particular geographic area and may communicate with a terminal device 110 (e.g., a UE) located within that coverage area.

The terminal device in the embodiment of the present disclosure may be referred to as a User Equipment (UE); a Mobile Station (MS); a Mobile Terminal (MT); a subscriber unit; a subscriber station; a Mobile Station; a remote station; a remote terminal; a mobile device; a user terminal; a terminal; a wireless communication device; a user agent; or a user device. The terminal device may include one or a combination of at least two of the following: an Internet of Things (IoT) device; a satellite terminal; a Wireless Local Loop (WLL) station; a Personal Digital Assistant (PDA); a handheld device with wireless communication function; a computing device or other processing device connected to a wireless modem; a server; a mobile phone; a tablet computer; a computer with wireless transceiver function; a handheld computer; a desktop computer; a Personal Digital Assistant; a portable media player; a smart speaker; a navigation device; a wearable device such as a smart watch, smart glasses, and a smart necklace, etc.; a Pedometer; digital TV; a virtual reality (VR) terminal device; an Augmented Reality(AR) terminal device; a wireless terminal in industrial control; a wireless terminal in self driving; a wireless terminal in remote medical surgery; a wireless terminal in smart grid; a wireless terminal in transportation safety; a wireless terminal in smart city; a wireless terminal in smart home; and a vehicle, a vehicle-mounted device, a vehicle-mounted module, a wireless modem, a handheld device, a Customer Premise Equipment (CPE), a smart home appliance, and the like in a vehicle networking system.

In some embodiments, the terminal device 110 may be any terminal device, including but not limited to a terminal device that uses a wired or wireless connection to the network device 120 or other terminal devices.

In some embodiments, the terminal device 110 may be used for device-to-device (D2D) communication.

The access network device 121 may include one or a combination of at least two of an Evolutionary Node B (eNB or eNodeB) in a Long Term Evolution (LTE) system, a Next Generation Radio Access Network (NG RAN) Device, a base station (gNB) in NR system, a small station, a micro station, a wireless controller in a Cloud Radio Access Network (CRAN), a wireless fidelity (Wi-Fi) access point, a transmission reception point (TRP), relay station, an access point, a vehicle device, a wearable device, a hub, a switch, a bridge, a router, and a network device in future evolution of Public Land Mobile Network (PLMN), etc.

The core network device 122 may be a 5G Core (5GC) device and may include one or a combination of at least two of an Access and Mobility Management Function (AMF), an Authentication Server Function (AUSF), a User Plane Function (UPF), a Session Management Function (SMF), a Location Management Function (LMF), and a Policy Control Function (PCF). In other embodiments, the core network device may also be an Evolved Packet Core (EPC) device of the LTE network, for example, a Session Management Function+Core Packet Gateway (SMF+PGW-C) device of the core network. It should be understood that the SMF+PGW-C may implement both functions of the SMF and the PGW-C. In the process of network evolution, the core network device 122 may be called by another name, or a new network entity may be formed by dividing the functions of the core network, which is not limited by the embodiment of the present disclosure.

The respective functional units in the communication system 100 may also establish connection between each other through next generation network (NG) interfaces to achieve communication.

For example, the terminal device establishes an air interface connection with the access network device through the NR interface for sending user plane data and control plane signaling. The terminal device can establish a control plane signaling connection with the AMF through the NG interface 1 (referred to as N1 for short). An access network device, such as a next generation radio access base station (gNB), can establish a user plane data connection with the UPF through an NG interface 3 (referred to as N3 for short). The access network device can establish a control plane signaling connection with the AMF through the NG interface 2 (referred to as N2 for short). The UPF may establish a control plane signaling connection with the SMF through the NG interface 4 (referred to as N4 for short). The UPF can interact user plane data with the data network through the NG interface 6 (referred to as N6 for short). The AMF may establish a control plane signaling connection with the SMF through the NG interface 11 (referred to as N11 for short). The SMF may establish a control plane signaling connection with the PCF through the NG interface 7 (referred to as N7 for short).

FIG. 1 exemplarily illustrates one base station, one core network device, and two terminal devices. In some embodiments, the wireless communication system 100 may include a plurality of base station devices and another number of terminal devices may be included within the coverage range of each base station, and the embodiment of the present disclosure is not limited thereto.

It should be noted that FIG. 1 only illustrates a system applicable to the present disclosure in the form of an example, and of course, the method shown in the embodiment of the present disclosure can also be applied to other systems. Further, the terms “system” and “network” are often used interchangeably herein. Herein, the term “and/or” is only an association relationship describing an association object, and means that there may be three relationships, for example, A and/or B, which may mean that A alone exists, A and B simultaneously exist, and B alone exists. In addition, the character “/” in this article generally indicates that the related objects before and after are in an “or” relationship. It should also be understood that the “indicate/indicating/indication” mentioned in the embodiments of the present disclosure may be a direct indication, an indirect indication, or an association relationship. For example, A indicates B, which may mean that A directly indicates B, for example, B can be acquired by A. It may also mean that A indicates B indirectly, for example A indicates C, and B can be acquired through C. It may also indicate that there is an association relationship between A and B. It should also be understood that “correspondence” mentioned in the embodiments of the present disclosure may indicate that there is a direct correspondence or indirect correspondence between the two elements, may indicate that there is a correlation relationship between the two elements, or may indicate a relationship between indicating and being indicated, configuring and being configured, or the like. It should also be understood that the “predefined”, “agreed in a protocol”, “predetermined”, or “predefined rule” mentioned in the embodiments of the present disclosure may be implemented by storing corresponding codes, tables, or other methods that can be used to indicate relevant information in devices (including, for example, terminal devices and network devices) in advance, and the present disclosure does not limit specific implementations thereof. For example, the term “predefined” may refer to “defined” in a protocol. It should also be understood that in the embodiment of the present disclosure, the “protocol” may refer to a standard protocol in the field of communication, and may include, for example, an LTE protocol, an NR protocol, and related protocols applied to future communication systems, which is not limited in the present disclosure.

In order to facilitate understanding of the technical solutions of the embodiments of the present disclosure, technologies related to the embodiments of the present disclosure will be described below, and the following related technologies can be arbitrarily combined with the technical solutions of the embodiments of the present disclosure as optional solutions, and all of them belong to the scope of protection of the embodiments of the present disclosure.

FIG. 2 is a schematic diagram of a system architecture based on a reference point presentation mode according to the embodiment of present disclosure. As shown in FIG. 2, the reference point presentation method can show that there may be interactions between corresponding Network Function (NF) services. The network functions include, for example: Access and Mobility Management Function (AMF) 201, Session Management Function (SMF) 202, Policy Control Function (PCF) 203, Application Function (AF) 204, and User Plane Function (UPF) 205. The system may further include: User Equipment (UE) 206, Radio Access Network (RAN) or Access Node (AN) 207, and Data Network (DN) 208.

FIG. 2 shows the following reference points: N1 (between UE 206 and AMF 201), N2 (between RAN 207 and AMF 201), N3 (between RAN 207 and UPF 205), N4 (between SMF 202 and UPF 205), N5 (between PCF 203 and AF 204), N6 (between UPF 205 and DN 208), N7 (between SMF 202 and PCF 203), N9 (between two UPFs 205), N11 (between AMF 201 and SMF 202), N14 (between two AMFs 201), N15 (in the case of non-roaming, between PCF 203 and AMF 201; or in the case of roaming, between PCF 203 and the visited network as well as AMF 201), and N16 (between two SMFs; not shown).

The following is an explanation of SMF, PCF, and AF:
SMF: including establishment, modification, and release of sessions; maintenance of tunnels between UPF and AN nodes; allocation and management of UE Internet Protocol (IP) addresses; selection and control of UPF functions; collection of charging data; and support for charging interfaces, etc.
PCF: supporting a unified policy framework to manage network behaviors and providing operator network control policies to other network elements and terminals.
AF: which may be an application within the operator, such as IP Multimedia Subsystem (IMS), or a third-party service, such as web services, videos, or games. If it is an AF within the operator and is in a trusted domain with other NFs, it directly interacts with and accesses other NFs; if the AF is not in a trusted domain, it needs a Network Exposure Function (NEF) to access other NFs.

The UE performs access layer connection with AN through a Uu port to exchange access layer messages and wireless data transmission, and the UE performs Non-Access Stratum (NAS) connection with AMF through an N1 port to exchange NAS messages. The AMF is a mobility management function in the core network, and the SMF is a session management function in the core network. In addition to performing mobility management on the UE, the AMF is also responsible for forwarding messages related to the session management between the UE and the SMF. PCF is a policy management function in the core network, which is responsible for formulating policies related to mobility management, session management, billing, etc. for the UE. The UPF is a user plane function in the core network, which performs data transmission with the external data network through an N6 interface and performs data transmission with the AN through an N3 interface.

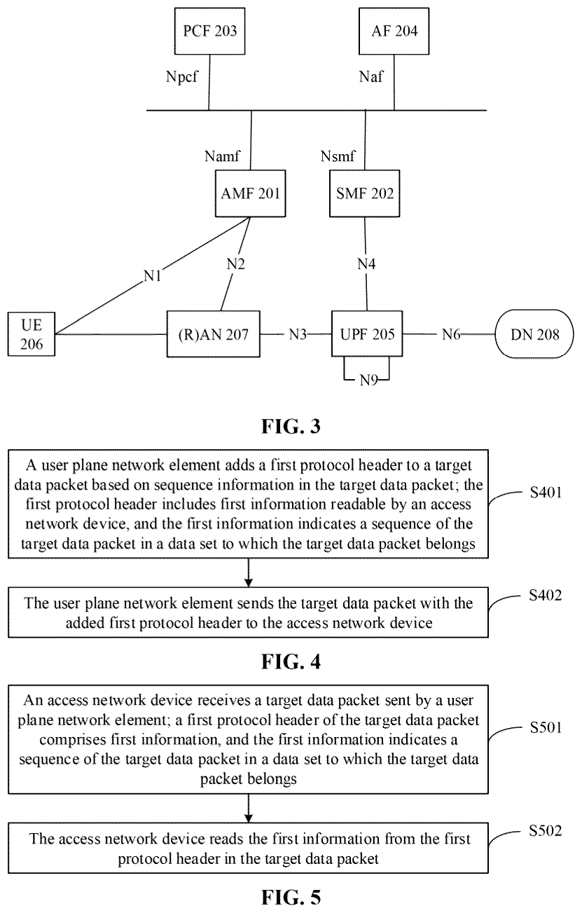

FIG. 3 is a schematic diagram of a system architecture based on a service-oriented presentation mode according to an embodiment of the present disclosure. As shown in FIG. 3, the difference between FIG. 3 and FIG. 2 is that the PCF 203, the AF 204, the AMF 201, and the SMF 202 interact through a service-oriented interface, the service-oriented interface provided by the PCF 203 is Npcf, the service-oriented interface provided by the AF 204 is Naf, the service-oriented interface provided by the AMF 201 is Namf, and the service-oriented interface provided by the SMF 202 is Nsmf.

In any embodiment of the present disclosure, the AN or RAN has the same meaning as the access network device, the UPF has the same meaning as the UPF network element, the AMF has the same meaning as the AMF network element, the SMF has the same meaning as the SMF network element, the PCF has the same meaning as the PCF network element, and the AF has the same meaning as the AF device.

It should be noted that, in the embodiment of the present disclosure, the communication mode between network elements is not limited to communication in an interface mode (corresponding to a reference point-based presentation mode) or communication in a service revoking mode (corresponding to a service-based presentation mode).

The application layer data that the UE can interact with an application server (which can be understood in the same way as the AF) includes at least one of the following: AR data, VR data, Cloud gaming-related data, live video data, etc., and the application layer data is usually obtained after specific encoding and/or compression. For example, in the encoding process, media data may be split into multiple data sets, and each data set is encoded independently. For example, a 100*100 pixel image (or picture) may be independently encoded, or the image may be split into 10 100*10 pixel image blocks, and each image block may be independently encoded.

Each data set may include a plurality of IP data packets, which are sent from the application server, reach the UPF via the data network, and then sent by the UPF to the access network device. The access network device allocates radio resources to send the IP data packets to the UE through the air interface. After receiving the data, the UE identifies the data set through protocol layers above the IP layer, and separately decodes each data set or further combines the respective data sets, to obtain the whole image. In some embodiments, the data set may include media units.

However, after multiple IP data packets belonging to a data set are sent from the application server, each data packet is routed independently in the process of reaching the UPF through the data network, so the data packets reaching the UPF become out of order. In the process that the UPF sends the data packets to the access network device, further out-of-order issues may occur. After the access network device obtains the multiple IP data packets belonging to a data set, the access network device cannot read the IP layer and the protocol layers above the IP layer, and therefore cannot distinguish the order of these data packets in the data set.

However, in some cases, the loss of a data packet in the data set may cause the UE to be unable to correctly decode the data after the data packet even if the data after the data packet is successfully sent to the UE. As a result, the data after the data packet become invalid information, and the transmission of the information becomes invalid transmission, which wastes air interface resources and has no practical use. Therefore, if the access network device cannot distinguish the order of these data packets in the data set, it cannot optimize the air interface transmission according to the order of data packets.

In order to facilitate understanding of the technical solutions of the embodiments of the present disclosure, the technical solutions of the present disclosure will be described in detail below with reference to specific examples. As an optional solution, the above related technologies can be arbitrarily combined with the technical solutions of the embodiments of the present disclosure, and all of them belong to the scope of protection of the embodiments of the present disclosure. Embodiments of the present disclosure include at least some of the following.

The embodiments of the present disclosure provide a communication method, apparatus and device, a storage medium, a chip, a product, and a program.

An embodiment of the present disclosure provides a communication method. The method includes the following operations.

A user plane network element adds a first protocol packet header to a target data packet based on sequence information in the target data packet; the first protocol packet header includes first information readable by an access network device, and the first information indicates a sequence of the target data packet in a data set to which the target data packet belongs.

The user plane network element sends the target data packet with the added first protocol packet header to the access network device.

An embodiment of the present disclosure provides a communication method. The method includes the following operations.

An access network device receives a target data packet sent by a user plane network element; a first protocol packet header of the target data packet comprises first information, and the first information indicates a sequence of the target data packet in a data set to which the target data packet belongs.

The access network device reads the first information from the first protocol packet header in the target data packet.

An embodiment of the present disclosure provides a communication method. The method includes the following operations.

A control plane network element receives description information of a service data flow and/or sequence number indication information.

The control plane network element sends the description information of the service data flow and/or the sequence number indication information to a user plane network element; the description information of the service data flow and/or the sequence number indication information are used for the user plane network element to add a first protocol packet header to a target data packet based on sequence information in the target data packet, the first protocol packet header comprises first information readable by an access network device, and the first information indicates a sequence of the target data packet in a data set to which the target data packet belongs.

An embodiment of the present disclosure provides a communication apparatus. The communication apparatus includes a processing unit and a communication unit.

The processing unit is configured to add a first protocol packet header to a target data packet based on sequence information in the target data packet; the first protocol packet header includes first information readable by an access network device, and the first information indicates a sequence of the target data packet in a data set to which the target data packet belongs.

The communication unit is configured to send the target data packet with the added first protocol packet header to the access network device.

An embodiment of the present disclosure provides a communication apparatus. The communication apparatus includes a communication unit and a reading unit.

The communication unit is configured to receive a target data packet sent by a user plane network element; a first protocol packet header of the target data packet comprises first information, and the first information indicates a sequence of the target data packet in a data set to which the target data packet belongs.

The reading unit is configured to read the first information from the first protocol packet header in the target data packet.

An embodiment of the present disclosure provides a communication apparatus. The communication apparatus includes a communication unit.

The communication unit is configured to receive description information of a service data flow and/or sequence number indication information.

The communication unit is further configured to send the description information of the service data flow and/or the sequence number indication information to a user plane network element; the description information of the service data flow and/or the sequence number indication information are used for the user plane network element to add a first protocol packet header to a target data packet based on sequence information in the target data packet, the first protocol packet header comprises first information readable by an access network device, and the first information indicates a sequence of the target data packet in a data set to which the target data packet belongs.

An embodiment of the present disclosure provides a communication device, including a processor and a memory.

The memory stores a computer program executable by the processor.

The processor is configured to, when executing the program, implement the method according to the first, second or third aspect.

An embodiment of the present disclosure provides a computer storage medium. The computer storage medium stores one or more programs, and the one or more programs are executable by one or more processors to implement the method of according to the first, second or third aspect.

An embodiment of the present disclosure provides a chip, including a processor. The processor is configured to call and run a computer program from a memory to implement the method according to the first, second or third aspect.

An embodiment of the present disclosure provides a computer program product. The computer program product includes a computer storage medium, and the computer storage medium stores a computer program. The computer program includes instructions executable by at least one processor. The instructions, when executed by the at least one processor, implement the method of according to the first, second or third aspect.

An embodiment of the present disclosure provides a computer program. The computer program enables a computer to execute the method according to the first, second or third aspect.

In the embodiments of the present disclosure, a user plane network element adds a first protocol packet header to a target data packet based on sequence information in the target data packet; the first protocol packet header includes first information readable by an access network device, and the first information indicates a sequence of the target data packet in a data set to which the target data packet belongs; and the user plane network element sends the target data packet with the added first protocol packet header to the access network device. In this way, the user plane network element sends the target data packet with the added first protocol packet header to the access network device, and the first information in the first protocol packet header can be read by the access network device. Thus, the access network device can determine the sequence of the target data packet in the data set, and thereby control air interface transmission based on the sequence of the target data packet in the data set.

FIG. 4 is a schematic flowchart of a communication method according to an embodiment of the present disclosure. As shown in FIG. 4, the method is applied to a user plane network element, and the method includes operations S401 and S402.

At operation S401, the user plane network element adds a first protocol packet header to a target data packet based on sequence information in the target data packet; the first protocol packet header includes first information readable by an access network device, and the first information indicates a sequence of the target data packet in a data set to which the target data packet belongs.

S402, the user plane network element sends the target data packet with the added first protocol packet header to the access network device.

In some embodiments, the user plane network element may include a UPF network element, or the user plane network element may include a Packet Data Network/Serving Gateway (P/S-GW). It should be understood that with the evolution of the protocol, the user plane network element may also include network elements of other names, for example, the user plane network element in the 6G network system or the user plane network element in the 7G network system, and the like, which is not limited in the embodiment of the present disclosure.

In some embodiments, the sequence information may be stored in the target data packet, or the user plane network element may determine the sequence information based on the fields stored in the target data packet. In some embodiments, the sequence information may represent a generation order and/or a transmission order of the target data packet. In some embodiments, the service data flow may be divided into a plurality of data packets for transmission, and the plurality of data packets include a target data packet. In some embodiments, the service data flow may be divided into one or more data sets for transmission, one data set includes one or more data packets, and the target data packet may be a data packet in a certain data set.

The sequence information in the embodiment of the present disclosure may be sequence information of a plurality of data packets obtained by splitting a service data flow or a message. In some embodiments, the service data flow may include complete data information to be sent, for example, the service data flow may include a video, a group of images, a image frame, and an image block frame. Among them, an image frame can be divided into a plurality of image blocks. In some embodiments, the service data flow may be referred to as a message, or the service data flow can be divided into multiple messages.

In some embodiments, the sequence information may be referred to as an order, a sequence, sequence information, a sequence number, or sequence number information.

In some embodiments, the target data packet may be an IP data packet, and the IP data packet includes at least one of a Real-time Transport Protocol (RTP) data packet, a Secure Real-time Transport Protocol (SRTP) data packet, a Transmission Control Protocol (TCP) data packet, a User Datagram Protocol (UDP) data packet, a HyperText Transfer Protocol (HTTP) data packet, an H.26x protocol data packet, a Moving Picture Experts Group (MPEG) data packet, or an Audio Video coding Standard (AVS) data packet. In other embodiments, the target packet may be one of an RTP packet, an SRTP packet, a TCP packet, a UDP packet, an HTTP packet, an H.26x protocol packet, an MPEG protocol packet, or an AVS protocol packet. H.26x may include one of H.263, H.264, or H.265, etc. AVS can also be called the “Advanced Audio and Video Coding of Information Technology” series standards.

In some embodiments, the target packet may include a payload and one or more protocol packet headers. For example, the target packet may include an IP packet header, an upper layer protocol packet header, and an upper layer protocol payload. As another example, the target data may include a UDP packet header and a UDP payload. The upper layer protocol may include a protocol(s) above the IP protocol. In some embodiments, the upper layer protocol may include at least one of the following: RTP, SRTP, TCP, UDP, HTTP, H.26x protocol, MPEG protocol, or AVS protocol.

In some embodiments, the first protocol packet header may be a packet header readable by the access network device. In some embodiments, the information included in the first protocol packet header can be used by the access network device. In some embodiments, the first protocol packet header may be one packet header or a plurality of packet headers. In some embodiments, the first protocol is a protocol for transmission between the access network device and the user plane device.

In some embodiments, after the first protocol packet header is added to the target data packet, the first protocol packet may be obtained, that is, the first protocol packet may include the first protocol packet header and the target data packet. In any embodiment of the present disclosure, the target data packet with added the first protocol packet header may be referred to as a first protocol data packet.

In some embodiments, the first information may be located in a sequence number field and/or an extension field and/or a predefined field of the first protocol packet header. In some embodiments, the first information may be represented by one or more bits.

In some embodiments, one or more data packets may be included in the data set, and the one or more data packets may include a target data packet. In some embodiments, the target data packet may be any one of one or more data packets or any two or more data packets in the data set. For example, in some cases, the target data may be any data packet in the data set, and in other cases, the target data packet may be all data packets in the data set.

In some embodiments, the first protocol packet header may further include indication information or identification information of the data set. For example, when the indication information or identification information of the data set is 5, and it represents that the identification of the data set to which the target data packet belongs is 5. In this way, the sequence of the target data packet in the data set to which the target data packet belongs can be determined through the indication information or identification information of the data set and the first information.

In some embodiments, the user plane network element may send the target data packet of the first protocol packet header to the access network device through the N3 interface. In some embodiments, the user plane network element may send the data packets in the data set to the access network device according to the sequence of the data packets in the data set. In some embodiments, the user plane network element may send the data packets in the data set to the access network device according to the sequence in which the data packets in the data set are received.

In an embodiment of the present disclosure, the user plane network element adds a first protocol packet header to the target data packet based on the sequence information in the target data packet. The first protocol packet header includes first information readable by the access network device, the first information indicates the sequence of the target data packet in the data set to which the target data packet belongs. The user plane network element sends the target data packet with the added first protocol packet header to the access network device. In this way, the user plane network element sends the target data packet with the added first protocol packet header to the access network device, and the first information in the first protocol packet header readable by the access network device. Thus, the access network device can determine the sequence of the target data packet in the data set, and thereby control air interface transmission based on the sequence of the target data packet in the data set.

As described above, in some implementation scenarios, when the transmission of the target data packet fails, the access network device no longer sends data packets after the target data packet to the terminal device, thereby saving air interface resources. Since the terminal device no longer receives data packets after the target data packet when the transmission of the target data packet fails, power consumption of the terminal device can be reduced.

In some embodiments, the first protocol packet header may include a General Packet Radio Service Tunneling Protocol-User plane (GTP-U) header. In some embodiments, the adding the first protocol packet header to the target data packet includes adding a General Packet Radio Service (GPRS) Tunneling Protocol-User Plane (GTP-U) header to the target data packet.

In some embodiments, the GTP-U packet header added to the target packet may include the first information. In some embodiments, the first information may include a sequence number field and/or an extension field and/or a predefined field in the GTP-U packet header.

In some embodiments, the first information is sequence information in the target data packet.

In some embodiments, if the sequence information in the target data packet is 25, the first information is also 25. In some embodiments, the sequence information in the plurality of data packets in the data set is 24, 25, and 26, respectively, and the first information in the first protocol packet header added to the plurality of data packets is also 24, 25, and 26, respectively.

In some embodiments, the sequence information in the target data packet may include at least one of a second sequence number in the target data packet, a target timestamp, a frame boundary flag, a start packet indicator of the data set, or an end packet indicator of the data set.

In another embodiment, the first information is a first sequence number of the target data packet in the data set to which the target data packet belongs, the first sequence number being determined by the user plane network element based on the sequence information in the target data packet.

In some embodiments, when the sequence information in the plurality of data packets in the data set is 24, 25, and 26, respectively, the first information in the first protocol packet header added to the plurality of data packets is 0, 1, and 2, respectively, or the first information is 1, 2, and 3, respectively.

In some embodiments, the first information may be is a first sequence number of the target data packet in the data set to which the target data packet belongs, the first sequence number being determined by the user plane network element based on sequence information in the target data packet, and at least one of: a second sequence number, a target timestamp, a frame boundary flag, a start packet indicator of the data set, or an end packet indicator of the data set.

In some embodiments, the user plane network element may determine one or more data packets belonging to the same data set based on at least one of: a second sequence number, a target timestamp, a frame boundary flag, a start packet indicator of the data set, or an end packet indicator of the data set, and then determine a first sequence number of the target data packet in the data set to which the target data packet belongs based on the second sequence number in the one or more data packets in each data set.

Exemplarily, the data packets having the same target timestamp belong to the same data set, and/or the data packets having the same or corresponding frame boundary flag belong to the same data set, and/or, among the data packets arragend in sequence, data packets within a range of a data packet indicated by the start packet indicator of the data set and a data packet indicated by the end packet indicator of the data set belong to the same data set.

In some embodiments, the sequence information in the target data packet includes sequence information in a second protocol packet header and/or sequence information in a second protocol payload.

In some embodiments, the second protocol includes one of: Real-time Transport Protocol (RTP), Secure Real-time Transport Protocol (SRTP), Transmission Control Protocol (TCP), User Datagram Protocol (UDP), Hypertext Transfer Protocol (HTTP), H.26x protocol, Moving Picture Experts Group (MPEG) protocol, or Audio Video Coding Standard (AVS) protocol.

In some embodiments, the second protocol payload may include a payload header and a data part. In some embodiments, the load header may be referred to as a payload header, and/or the data part may be referred to as a payload body part or a payload body part. In some embodiments, the first information may be included in the payload header, and/or may be included in the data part.

In some embodiments, the sequence information may be included in a second protocol packet header (also referred to as a second protocol header), and/or the sequence information may be included in a second protocol payload. In a case where the sequence information is included in the second protocol payload, the sequence information may be included in the second protocol payload header or a data part of the second protocol payload.

In some embodiments, the sequence information includes at least one of a second sequence number, a target timestamp, a frame boundary flag, a start packet indicator of the data set, or an end packet indicator of the data set.

In some embodiments, the user plane network element may determine the first information based on at least one of the second sequence number, the target timestamp, the frame boundary flag, the start packet indicator of the data set, or the end packet indicator of the data set. For example, the user plane network element may determine the first information based on the second sequence number, and based on the target timestamp and/or the frame boundary flag. For another example, the user plane network element may determine the first information based on the second sequence number and based on the start packet indicator of the data set and/or the end packet indicator of the data set.

In some embodiments, the method further includes that, the user plane network element receives description information of the service data flow and/or sequence number indication information sent by the control plane network element; and the user plane network element reads sequence information in the target data packet based on the description information of the service data flow and/or the sequence number indication information.

In some embodiments, the control plane network element may also be referred to as a control network element in other embodiments.

In some embodiments, the control plane network element may include a PCF network element and/or an SMF network element, or the control plane network element may include a Mobility Management Entity (MME). It should be understood that with the evolution of the protocol, the control plane network element may also include network elements of other names, for example, the control plane network element in the 6G network system or the control plane network element in the 7G network system, and the like, which is not limited in the embodiment of the present disclosure.

In some embodiments, a plurality of data packets may be obtained by dividing the service data flow, for example, the service data flow may be divided into a plurality of data sets, and each data set may include one or more data packets. Each data packet obtained by dividing the service data flow may include packet header information, and the packet header information of each data packet may include description information of the service data flow, or may be associated with description information of the service data flow.

In some embodiments, the sequence number indication information indicates at least one of the following: reading sequence information, whether or not to add first information to a first protocol packet header, a protocol associated with the reading sequence information, performing data set level processing on the service data flow, a position for reading the sequence information, and the data set being in frames or in Network Abstraction Layer (NAL) units.

In some embodiments, when the user plane network element receives the description information of the service data flow, the user plane network element may read the sequence information in the target data packet corresponding to the description information of the service data flow. In some embodiments, when the user plane network element receives the sequence number indication information, the user plane network element may read the sequence information in the target data packet. In some embodiments, when the user plane network element receives the description information and the sequence number indication information of the service data flow, the user plane network element may read the sequence information in the target data packet.

In some embodiments, the sequence number indication information may also be referred to as sequence indication information, order indication information, sequence addition indication information, or the like in other embodiments.

In some embodiments, the description information includes at least one of packet header information, an application identifier, or a service identifier. The packet header information includes at least one of a source Internet Protocol IP address, a destination IP address, a source port, a destination port, a source medium access control MAC address, and a destination MAC address.

In some embodiments, the application identifier may be an application identifier corresponding to the service data flow. The application identifier may include an identifier of an application program or application software, or the like. For example, the application identifier may include the identifier of Tencent Video, the identifier of iQiyi Video, the identifier of WeChat, or the like. The application identifier may be an internal application identifier of an operator or an application identifier of a third-party application.

In some embodiments, the service identifier may be a service identifier corresponding to the service data flow. Different service identifiers may correspond to different services of the service data flows. For example, the service identifier may include an identifier of a voice communication service, an identifier of a video playback service, an identifier of a video communication service, an identifier of a web browsing service, or the like. The service identifier may be an internal service identifier of the operator or a service identifier of a third-party service.

In some embodiments, the packet header information may further include at least one of IP packet header information, packet header information of an upper layer protocol of an IP protocol, or the like.

In some embodiments, the sequence number indication information comprises at least one of:
explicit indication information and/or implicit indication information indicating whether to add the first information to the first protocol packet header;
second protocol indication information, including one of: a Real-time Transport Protocol (RTP), a Transmission Control Protocol (TCP), a User Datagram Protocol (UDP), a Hypertext Transfer Protocol (HTTP), a H.26x protocol, a Moving Picture Experts Group (MPEG) protocol, or an Audio Video Coding Standard (AVS) protocol;
second information indicating performing data set level processing on the service data flow;
third information indicating a position for reading the sequence information in the target data packet; or
fourth information indicating that the data set is in frames or the data set is in network abstraction layer (NAL) units.

In some embodiments, the display indication information may be one or more bits of information, and different values of the one or more bits of information indicate whether or not to add the first information to the first protocol packet header. For example, in a case where bit information is 1, it indicates adding the first information to the first protocol packet header; in a case where the bit information is 0, it indicating not adding the first information to the first protocol packet header.

In some embodiments, the implicit indication information may be a target domain or a target field in signaling, and the target domain or the target field may be used to configure related parameters for reading sequence information in a target data packet, and/or configure an indication of adding the first information to the first protocol packet header. If the target domain or the target field is carried in the signaling, it indicates that the first information is to be added to the first protocol packet header. If the target domain or the target field is not carried in the signaling, or the target domain or the target field is not configured with related parameters for reading sequence information in the target data packet, or the target domain or the target field is not configured with an indication of adding the first information to the first protocol packet header, it indicates that the first information is not to be added to the first protocol packet header. In some embodiments, the related parameters for reading the sequence information in the target data packet may include at least one of the following: an indication of reading the sequence information, an indication of a protocol associated with reading the sequence information, an indication of performing data set level processing on the service data flow, an indication of a position for reading the sequence information, and an indication of the data set being in frame or NAL units.

In some embodiments, when the user plane network element obtains the second protocol indication information, the user plane network element may read the sequence information from the data packet corresponding to the second protocol in the target data packet, for example, the sequence information may be read from the second protocol packet header (also referred to as the second protocol header) and/or the sequence information may be read from the second protocol payload.

In some embodiments, when the user plane network element obtains the second information, the user plane network element may determine that the data set processing is performed on the service data flow, that is, the service data flow is sent through a plurality of data sets, so that the user plane network element can read the sequence information in the target data packet, and the first information is included in the first protocol packet header added to the target data packet.

In some embodiments, when the user plane network element obtains the third information, the user plane network element may read the sequence information in the target data packet based on the position for reading the sequence information in the target data packet indicated by the third information, and add a first protocol packet header including the first information to the target data packet.

In some embodiments, the third information may further indicate at least one of a second protocol data packet, a second protocol packet header (also referred to as a second protocol header), a second protocol payload, a second protocol payload header, a second protocol extension header, a target domain or a target field for reading the sequence information.

In some embodiments, in a case where the data set is in frames, one data set may correspond to one image frame, or one data set may correspond to a plurality of image frames. In some embodiments, in a case where the data set is in NAL units, one data set may correspond to one image block, or one data set may correspond to a plurality of image blocks. One image frame can be divided into a plurality of image blocks. The sizes of the plurality of image blocks may be the same or different.

In some embodiments, in a case where the fourth information indicates that the data set is in frames, the user plane network element may determine the sequence information from the information read from the second protocol packet header. In some embodiments, in a case where the fourth information indicates that the data set is in NAL units, the user plane network element may determine the sequence information from the information read from the second protocol packet header and the second protocol payload header, and thereby add the first protocol packet header including the first information to the target data packet based on the sequence information.

In some embodiments, the position includes at least one of an RTP header, an RTP payload header, or an RTP extension header.

In some embodiments, in other embodiments, the position information may include at least one of a TCP header, a TCP payload header, a TCP extension header, a UDP header, a UDP payload header, a UDP extension header, an HTTP header, an HTTP payload header, an HTTP extension header, an H.26x header, an H.26x payload header, an H.26x extension header, an MPEG header, an MPEG extension header, an AVS header, an AVS payload header, an AVS extension header, or the like.

In some embodiments, the method further includes: in a case where a position for reading the sequence information in the target data packet is an RTP header, or a frame is used as a data set, the user plane network element determines a sequence of the target data packet in a data set to which the target data packet belongs based on at least one of the following: a target timestamp, a frame boundary flag and a second sequence number.

In any embodiment of the present disclosure, the sequence of the target data packet in the data set to which the target data packet belongs may be the first sequence number of the target data packet in the data set to which the target data packet belongs.

In some embodiments, in a case where a position for reading the sequence information in the target data packet is an RTP header, or the data set is in frames, the user plane network element determines data packets belonging to a same data set based on at least one of a target timestamp or a frame boundary flag. The user plane network element may determine the sequence of the target data packet in the data set to which the target data packet belongs based on the second sequence numbers of the data packets of the same data set.

In some embodiments, the user plane network element may determine, based on the received third information, that a position for reading the sequence information in the target data packet is an RTP header, or determine that the data set is in frames based on the received fourth information.

In some embodiments, data packets having the same target timestamp may belong to the same data set. In some embodiments, data packets having the same frame boundary flag or response may belong to the same data set.

Exemplarily, if the first data set includes three data packets, and the second sequence numbers of the three data packets are 0, 1, and 2, respectively, then the first information included in the first protocol packet header added to the three data packets in the first data set is 0, 1, and 2, respectively. Further exemplarily, if the second data set includes four data packets, and the second sequence numbers of the four data packets are 3, 4, 5, and 6, respectively, then the first information included in the first protocol packet header added to the four data packets in the second data set is 0, 1, 2, and 3, respectively; or 1, 2, 3, or 4, respectively; or 3, 4, or 5, and 6, respectively.

In some embodiments, the method further includes: in a case where a position for reading the sequence information in the target data packet includes an RTP payload header, or the data set is in NAL units, the user plane network element determines a sequence of the target data packet in the data set to which the target data packet belongs based on at least one of a start packet indicator of the data set, an end packet indicator of the data set, or a second sequence number.

In some embodiments, in a case where a position for reading the sequence information in the target data packet includes an RTP payload header or the data set is in NAL units, the user plane network element determines data packets belonging to a same data set based on at least one of a start packet indicator of the data set, an end packet indicator of the data set, or a second sequence number. The user plane network element may determine the sequence of the target data packet in the data set to which the target data packet belongs based on the second sequence numbers of the data packets of the same data set.

In some embodiments, the user plane network element may determine, based on the received third information, that a position for reading the sequence information in the target data packet includes an RTP payload header, or determine that the data set is in NAL units based on the received fourth information.

In some embodiments, in some implementations, the position for reading the sequence information in the target data packet includes an RTP payload header, which may include that: the position for reading the sequence information in the target data packet includes an RTP packet header and an RTP payload header, or the position for reading the sequence information in the target data packet is an RTP payload header. Exemplarily, the user plane network element may first read an RTP packet header, and get at least one of the following from the RTP packet header: a target timestamp, a frame boundary flag, or a second sequence number; and then read the RTP payload header, and get at least one of the following from the RTP payload header: a start packet indicator of the data set, an end packet indicator of the data set, or a second sequence number. Also exemplarily, in a case where the user plane network element indicates that the position for reading the sequence information in the target data packet includes an RTP payload header based on the received third information, or in a case where the user plane network element indicates that the data set is in NAL units based on the received fourth information, the user plane network element may get at least one of the following from the RTP payload header: a start packet indicator of the data set, an end packet indicator of the data set or a second sequence number; or the user plane network element may get at least one of the following from the RTP payload header: a target timestamp, a frame boundary flag, or a second sequence number; and then read the RTP payload header, and gett least one of the following from the RTP payload header: a start packet indicator of the data set, an end packet indicator of the data set or a second sequence number.

In some embodiments, the user plane network element may determine data packets belonging to the same data set based on the start packet indicator and the second sequence number of the data set, or the user plane network element may determine data packets belonging to the same data set based on the end packet indicator of the data set and the second sequence number, or the user plane network element may determine data packets belonging to the same data set based on the start packet indicator of the data set, the end packet indicator of the data set, and the second sequence number.

In some embodiments, the second sequence number is a sequence number with which data is generated or sent from an application server, and the target timestamp is a timestamp when data is generated or sent from the application server.

FIG. 5 is a schematic flowchart of another communication method according to an embodiment of the present disclosure. As shown in FIG. 5, the method is applied to an access network device, and the method includes operations S510 and S502.

At operation S501, the access network device receives the target data packet sent by the user plane network element. A first protocol packet header of the target data packet includes first information indicating a sequence of the target data packet in a data set to which the target data packet belongs.

At operation S502, the access network device reads the first information from the first protocol packet header in the target data packet.

In some embodiments, the access network device may determine a position for reading the first information according to pre-configuration, and read the first information from a first protocol packet header in the target data packet based on the position. The pre-configuration may include indication information of a domain or field in which the first information is located. In some embodiments, in another embodiment, the access network device may determine the position for reading the first information according to the configuration information sent by the user plane network element, or the access network device may determine the position for reading the first information according to the position indicated by other information in the first protocol packet header, so as to read the first information from the first protocol packet header in the target data packet based on the position.

In some embodiments, the access network device may further read the indication information or the identification information of the data set from the first protocol packet header, thereby determining the data set to which the target data packet belongs based on the indication information or the identification information of the data set.

In the embodiment of the present disclosure, the access network device reads the first information, so that the access network device can determine the sequence number of the target data packet in the data set to which the target data packet belongs, and can further control the air interface transmission according to the need of the target data packet in the data set to which the target data packet belongs, for example, optimizing the air interface transmission.

In some embodiments, the operation that the access network device reads the first information from the first protocol packet header in the target data packet includes that, the access network device reads the first information from a GTP-U packet header in the target data packet.

In some embodiments, the first information is sequence information in the target data packet, or the first information is a first sequence number of the target data packet in the data set to which the target data packet belongs, the first sequence number being determined by the user plane network element based on the sequence information in the target data packet.

In some embodiments, the sequence information in the target data packet includes sequence information in a second protocol packet header and/or sequence information in a second protocol payload, the second protocol including one of:

RTP, SRTP, TCP, UDP, HTTP, H.26x protocol, MPEG protocol, or AVS protocol.

In some embodiments, the sequence information includes at least one of a second sequence number, a target timestamp, a frame boundary flag, a start packet indicator of a data set, or an end packet indicator of a data set.

In some embodiments, the second sequence number is a sequence number with which data is generated or sent from an application server, and the target timestamp is a timestamp when data is generated or sent from the application server.

In some embodiments, the method further includes that, in a case where the access network device fails to send the target data packet to the terminal device, the access network device does not send remaining data packet(s) to the terminal device; the remaining data packet(s) is/are data packet(s) in the data set which is/are sequenced after the target data packet.

In some embodiments, failing to send the target data packet to the terminal device may include failing to send the target data packet to the terminal device one or more times.

In some embodiments, failing to send the target data packet to the terminal device may include that the target data packet is lost, or the target data packet sent by the access network device does not reach the terminal device, or an error occurs to the target data packet, or the access network device does not receive a feedback message for the target data packet.

For example, when the access network device obtains the data packets of which the sequences are 0, 1, and 2 in the data set respectivley, the access network device may first send the data packet of which the sequence is 0 to the terminal device; send the data packet of which the sequence is 1 when transmission of the data packet of which the sequence is 0 is successful; do not send the data packets of which the sequences are 1 and 2 respectively to the terminal device when transmission of the data packet of which the sequence is 0 fails; send the data packet of which the sequence is 2 when transmission of the data packet of which the sequence is 1 is successful; no longer send the data packet of which the sequence is 2 when the transmission of the data packet of which the sequence is 1 fails.

In some embodiments, when the transmission of the target data packet fails, the access network device may continue to send the target data packet to the terminal device after a preset time interval; or the access network device may send the target data packet to the terminal device when determining that the channel quality between the access network device and the terminal device is greater than a certain threshold; or the access network device may discard the data set including the target data packet.

In other embodiments, unlike the scheme described above, the remaining data packet(s) is/are a data packet(s) received by the access network device after the target data packet. In this case, the order in which the access network device sends the data packets to the terminal device coincides with the order in which the data packets sent by the user plane network element are received.

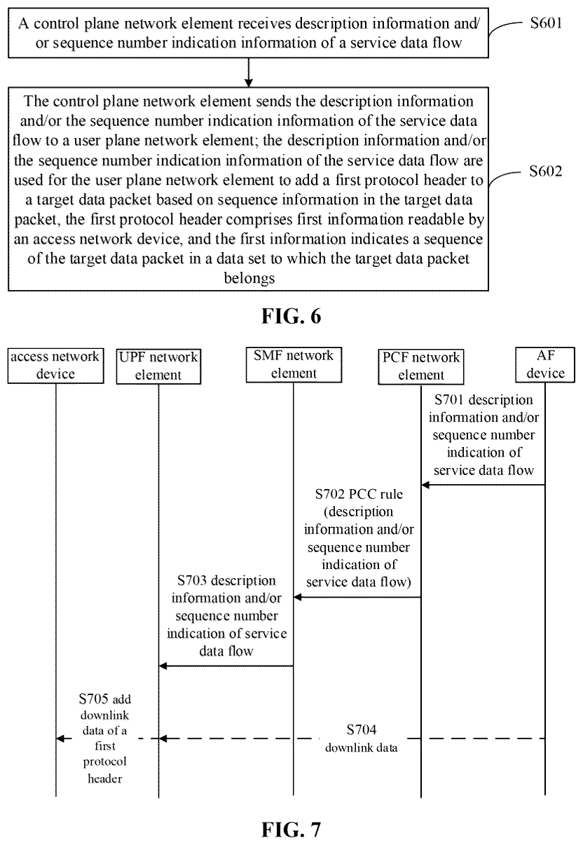

FIG. 6 is a schematic flowchart of yet another communication method according to an embodiment of the present disclosure. As shown in FIG. 6, the method is applied to a control plane network element, and the method includes operatioin S601 and S602.

At operation S601, the control plane network element receives description information of a service data flow and/or sequence number indication information.

At operation S602, the control plane network element sends the description information of the service data flow and/or the sequence number indication information to a user plane network element. The description information of the service data flow and/or the sequence number indication information are used for the user plane network element to add a first protocol packet header to the target data packet based on the sequence information in the target data packet. The first protocol packet header includes first information readable by an access network device, and the first information indicates a sequence of the target data packet in a data set to which the target data packet belongs.

In some embodiments, the control plane network element receives the description information of the service data flow and/or the sequence number indication information, and may include that the control plane network element receives the description information of the service data flow and/or the sequence number indication information sent by the application server.

In some embodiments, the control plane network element may include a PCF network element and an SMF network element, the PCF network element receives the description information of the service data flow and/or the sequence number indication information, sends the description information of the service data flow and/or the sequence number indication information to the SMF network element, and the SMF network element sends the received description information of the service data flow and/or the sequence number indication information to the user plane network element.

In some embodiments, the description information includes at least one of packet header information, an application identifier, or a service identifier. The packet header information includes at least one of a source IP address, a destination IP address, a source port, a destination port, a source MAC address, or a destination MAC address.

In some embodiments, the sequence number indication information comprises at least one of:
explicit indication information and/or implicit indication information, wherein the explicit indication information and/or the implicit indication information indicate whether to add the first information to the first protocol packet header;
second protocol indication information, wherein the second protocol comprises one of: Real-time Transport Protocol (RTP), Transmission Control Protocol (TCP), User Datagram Protocol (UDP), Hypertext Transfer Protocol (HTTP), H.26x protocol, Moving Picture Experts Group (MPEG) protocol, or Audio Video Coding Standard (AVS) protocol;
second information indicating performing data set-level processing on the service data flow;
third information indicating a position for reading the sequence information in the target data packet; or
fourth information indicating that the data set is in frames, or indicates that the data set is in NAL units.

In some embodiments, the position includes at least one of an RTP header, an RTP payload header, or an RTP extension header.

In some embodiments, embodiments of the present disclosure may provide another communication method, and the communication method may be applied to an application server, the method includes that, the application server sends description information of a service data flow and/or sequence number indication information to a control plane network element, and the description information of the service data flow and/or sequence number indication information are to be sent by the control plane network element to a user plane network element.

Hereinafter, embodiments of the embodiments of the present disclosure will be described.

In the embodiment of the present disclosure, the application function (AF) device (corresponding to the above application server) provides service data flow description information (corresponding to the description information of the service data flow in the above embodiment) and sequence number indication (corresponding to the sequence number indication information in the above embodiment) of the service data flow to the PCF network element located in the core network.

The service data flow description information may be service data flow filter information. The data flow filter information is a characteristic of the user plane packet header, for example, for IP-type data, it may include at least one of the following: a source IP address, a destination IP address, a source port number, a destination port number, or the like; and for Ethertype data, it may include at least one of the following: a source MAC address, a destination MAC address, or the like.

The sequence number indication indicates adding sequence number information that can be identified by the access network device to the data packet of the service data flow, for example, adding sequence number information of the data packet to the GTP-U protocol layer of the 3GPP protocol.

In some embodiments, the sequence number indication may be one or a combination of two or more of the following:
an explicit flag bit, e.g. 1 to indicate addition, 0 to indicate no addition;
protocol types above the IP layer, such as one of the following: TCP, UDP, RTP, HTTP, H.26x (H.263/H.264/H.265, etc.), MPEG, AVS, or etc. ;
an indication indicating performing data set level processing on the service data flow;
a position indicating where to read sequence information of data packets in an upper layer protocol (corresponding to the second protocol described above), for example, sequence information of data packets is obtained by reading an RTP header, sequence information of data packets is obtained by reading an RTP payload header, or sequence information of data packets is obtained by reading an RTP extension header;
an indication indicating that the data set is in frames or the data set is in NAL units, in this case, the indication of the position for reading the sequence information is an implicit indication, for example, when it indicates that the data set is in frames, the sequence information of the data packets is obtained by reading the RTP header; when it indicates that the data set is in NAL units, the sequence information of the data packets is obtained by reading the RTP payload header.

In some embodiments, the sequence number information (corresponding to the first information or the first sequence number described above) that can be identified by the added access network device may be one or a combination of two or more of the following:
sequence information of the data packet read from the upper layer protocol, which may be, for example, at least one of: a a sequence number with which data is generated or sent from an application server, a timestamp when data is generated or sent from the application server, a frame boundary flag, a start/end packet indicator of a data set, or the like; or
a sequence number of the data packet in the data set to which the data packet belongs, the sequence number being assigned by the core network element based on the information read from the upper layer protocol.

In some embodiments, the PCF network element determines a Policy Controland Charging (PCC) rule for the service data flow according to the request of the application function device, including service data flow description information and/or sequence number indication of the service data flow, and sends the PCC rule to the SMF network element, and the SMF network element sends the service data flow description information and/or sequence number indication to the UPF network element.

FIG. 7 is a schematic flowchart of still another communication method according to an embodiment of the present disclosure. As shown in FIG. 7, the method includes the operations S701 to S705.

At operation S701, the AF device sends service data flow description information and/or sequence number indication to the PCF network element.

At operation S702, the PCF network element sends a PCC rule to the SMF network element, and the PCC rule includes service data flow description information and/or sequence number indication.

At operation S703, the SMF network element sends service data flow description information and/or sequence number indication to the UPF network element.

At operation S704, the UPF network element receives downlink data, and the downlink data includes a target data packet.

In some embodiments, the downlink data received by the UPF network element may be sent by the AF device or may be sent by another device.

At operation S705, the UPF network element sends downlink data with the added first protocol packet header to the access network device, and the first protocol packet header includes first information readable by the access network device.

The following is the processing of downlink (DL) data by the UPF based on the information obtained from the control plane.

For downlink data, the UPF network element receives data (downlink data) from the data network, and the UPF network element matches the received data using the service data flow description information to determine whether or not to add sequence number information (corresponding to the first information described above) that can be identified by the access network device to the data. For example, the UPF network element obtains the service data flow description information of which the IP-5 tuple is {source IPa, target IPb, source port number c, target port number d, protocol type e} and the sequence number indication in S703; then when the UPF network element receives the downlink data with the data packet hearder information matching the IP-5 tuple from the external data network, the UPF network element reads the sequence information of the data packet in the upper layer protocol of the data packet, determines the sequence information (corresponding to the aforementioned sequence or the first sequence number of the target packet in the data set to which the target packet belongs) that can be identified by the access network device according to the sequence information of the data packet in the upper layer protocol. The UPF network element then adds the determined sequence number information that can be identified by the access network device to the data packet header and sends the data packet to the access network device. Here, the upper layer protocol is a protocol above the IP layer, for example, one of the following: TCP, UDP, RTP, HTTP, H.26x (H.263/H.264/H.265, etc.), MPEG, AVS, etc. The sequence number information that can be identified by the access network device determined by the UPF network element can be added at any position of the data packet header readable by the access network device, for example, in the GTP-U protocol layer data packet header of the 3GPP protocol. The access network device schedules the DL data according to the sequence number information carried in the DL data packet header received from the UPF network element, for example, when a data packet cannot be sent, data packets belonging to the same data set having sequence numbers after the data packet are considered as invalid data packet and no longer sent.

Examples of the specific operations of the UPF are given below based on the RTP protocol layer.
Mode 1: The sequence number indication received by the UPF network element from the SMF network element is an explicit flag bit, and/or an RTP type indication, and/or a data set level processing indication, and/or an RTP header reading indication. The UPF network element reads the RTP header of the RTP data received by the data network, and obtains at least one of: a sequence number with which data is generated or sent from an application server, a timestamp when data is generated or sent from the application server, a frame boundary flag, or etc. The UPF network element may directly add the information to the data packet header readable by the access network device, or the UPF network element may assign a sequence number for the data packet in the data set to which the data packet belongs according to the information, and add the sequence number to the data packet header readable by the access network device. This method can be used in a case where the data set is in frames, for example, data packets belonging to a same data set can be determined by a timestamp when data is generated or sent from the application server (data in a same frame have a same timestamp), or a frame boundary flag, and then the sequence number of the data packet in the data set to which the data packet belongs can be determined according to the sequence number with which data is generated or sent from an application server.
Mode 2: The sequence number indication received by the UPF network element from the SMF network element is an explicit flag bit, and/or an RTP type indication, and/or a data set level processing indication, and/or an RTP header reading indication, and/or an RTP payload header reading indication. The UPF network element reads the RTP header of the RTP data received by the data network to obtain at least one of: a sequence number with which data is generated or sent from an application server, a timestamp when data is generated or sent from the application server, or a frame boundary flag; and the UPF network element further reads the RTP payload header of the RTP data received by the data network to obtain information such as a start/end packet indicator of the data set. The UPF network element may directly add the information to the data packet header readable by the access network device, or the UPF network element may assign a sequence number for the data packet in the data set according to the information, and add the sequence number to the data packet header readable by the access network device. This method can be used in a case where the data set is in NAL units, for example, data packets belonging to the same data set are determined through the start/end packet indicator of the data set obtained from the RTP payload header, and then the sequence number of the data packet in the data set to which the data packet belongs can be determined based on the sequence number with which data is generated or sent from an application server.

In the embodiment of the present disclosure, it is ensured that the access network device can make out the order of the data packets in the data set, so that the access network device can optimize the air interface transmission according to the order of the data packets, for example, when a data packet cannot be sent, one or more data packet(s) belonging to the same data set having a sequence number after the data packet is/are considered as an invalid data packet(s), and the invalid data packet(s) is/are no longer sent.

It should be noted that the embodiment of the present disclosure can be applied not only to a 5G network, but also to a future 3GPP network.

The preferred embodiments of the present disclosure have been described in detail above with reference to the accompanying drawings, but the present disclosure is not limited to the specific details in the above-described embodiments. Within the scope of the technical concept of the present disclosure, various simple modifications can be made to the technical solutions of the present disclosure, and these simple modifications all fall within the scope of protection of the present disclosure. For example, various specific technical features described in the above-described detailed description can be combined in any suitable manner without contradiction, and various possible combinations will not be described separately in present disclosure in order to avoid unnecessary repetition. For example, various embodiments of the present disclosure may be combined arbitrarily, and as long as they do not violate the idea of the present disclosure, they should also be regarded as the content of the present disclosure. For another example, on the premise that there is no conflict, each embodiment described in the present disclosure and/or the technical features in each embodiment can be arbitrarily combined with the prior art, and the technical solution obtained after the combination should also fall within the scope of protection of the present disclosure.

It should also be understood that in various method embodiments of the present disclosure, the size of the sequence number of the above-described processes does not mean the sequence of execution, and the sequence of execution of each process should be determined by its function and internal logic, and should not constitute any limitation on the implementation of the embodiments of the present disclosure. In addition, in the embodiment of the present disclosure, the terms “downlink”, “uplink”, and “sidelink” are used to indicate the transmission direction of signals or data, wherein “downlink” is used to indicate that the transmission direction of signals or data is a first direction sent from the station to the user equipment of the cell, “uplink” is used to indicate that the transmission direction of signals or data is a second direction sent from the user equipment of the cell to the station, and “sidelink” is used to indicate that the transmission direction of signals or data is a third direction sent from the user equipment 1 to the user equipment 2. For example, “downlink signal” indicates that the transmission direction of the signal is the first direction. In addition, in the embodiment of the present disclosure, the term “and/or” is an association relationship describing an association object, and indicates that there may be three types of relationships. Specifically, A and/or B may represent three cases of A exists alone, both A and B exist, and B exists alone. In addition, the character “/” in this article generally indicates that the related objects before and after are in an “or” relationship.

FIG. 8 is a schematic structural diagram of a communication apparatus according to an embodiment of the present disclosure, and is applied to a terminal device. As shown in FIG. 8, the communication device 800 includes a processing unit 801 and a communication unit 802.

The processing unit 801 is configured to add a first protocol packet header to a target data packet based on sequence information in the target data packet. The first protocol packet header includes first information readable by an access network device, the first information indicates a sequence of the target data packet in a data set to which the target data packet belongs.

The communication unit 802 is configured to send the the target data packet with the added first protocol packet header to the access network device.

In some embodiments, the processing unit 801 is further configured to add a GTP-U packet header to the target data packet.

In some embodiments, the first information is sequence information in the target data packet, or the first information is a first sequence number of the target data packet in the data set to which the target data packet belongs, the first sequence number being determined by the user plane network element based on the sequence information in the target data packet.

In some embodiments, the sequence information in the target data packet includes sequence information in a second protocol packet header and/or sequence information in a second protocol payload, and the second protocol includes one of:

Real-time Transport Protocol (RTP), Secure Real-time Transport Protocol (SRTP), Transmission Control Protocol (TCP), User Datagram Protocol (UDP), Hypertext Transfer Protocol (HTTP), H.26x protocol, Moving Picture Experts Group (MPEG) protocol, Audio Video Coding Standard (AVS) protocol.

In some embodiments, the sequence information includes at least one of:

a second sequence number, a target timestamp, a frame boundary flag, a start packet indicator of the data set, or an end packet indicator of the data set.

In some embodiments, the communication unit 802 is further configured to receive description information of the service data flow and/or sequence number indication information sent by the control plane network element.

The processing unit 801 is further configured to read sequence information in the target data packet based on the description information of the service data flow and/or the sequence number indication information.

In some embodiments, the description information includes at least one of packet header information, an application identifier, or a service identifier;

The packet header information includes at least one of a source IP address, a destination IP address, a source port, a destination port, a source MAC address, and a destination MAC address.

In some embodiments, the sequence number indication information comprises at least one of:
explicit indication information and/or implicit indication information indicating whether to add the first information to the first protocol packet header;
second protocol indication information including one of: Real-time Transport Protocol (RTP), Transmission Control Protocol (TCP), User Datagram Protocol (UDP), Hypertext Transfer Protocol (HTTP), H.26x protocol, Moving Picture Experts Group (MPEG) protocol, or Audio Video Coding Standard (AVS) protocol;
second information indicating performing data set-level processing on the service data flow;
third information indicating a position for reading the sequence information in the target data packet; or
fourth information indicating that the data set is in frames, or indicating that the data set is in Network Abstraction Layer (NAL) units.

In some embodiments, the position includes at least one of a RTP header, a RTP payload header, or a RTP extension header.

In some embodiments, the processing unit 801 is further configured to determine the sequence of the target data packet in the data set to which the user plane network element belongs based on at least one of: a target timestamp, a frame boundary flag, or a second sequence number, in a case where the position for reading the sequence information in the target data packet is an RTP header, or the data set is in frames,

In some embodiments, the processing unit 801 is further configured to determine the sequence of the target data packet in the data set to which the target data packet belongs based on at least one of: a start packet indicator of the data set, an end packet indicator of the data set, or a second sequence number, in a case where the position for reading the sequence information in the target data packet is an RTP payload header, or the data set is in NAL units.

In some embodiments, the second sequence number is a sequence number with which data is generated or sent from an application server, and the target timestamp is a timestamp when data is generated or sent from the application server.

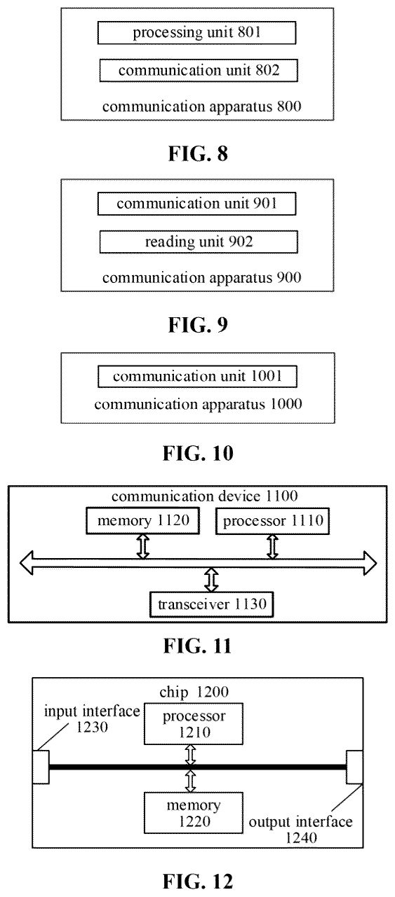

FIG. 9 is a schematic structural diagram of another communication apparatus according to an embodiment of the present disclosure, and is applied to a terminal device. As shown in FIG. 9, the communication device 900 includes a communication unit 901 and a reading unit 902.

The communication unit 901 is configured to receive a target data packet sent by a user plane network element. A first protocol packet header of the target data packet includes first information indicating a sequence of the target data packet in a data set to which the target data packet belongs.

The reading unit 902 is configured to read the first information from the first protocol packet header in the target data packet.

In some embodiments, the reading unit 902 is configured to read the first information from a GTP-U packet header in the target data packet.

In some embodiments, the first information is sequence information in the target data packet, or the first information is a first sequence number of the target data packet in the data set to which the target data packet belongs, the first sequence number being determined by the user plane network element based on the sequence information in the target data packet.

In some embodiments, the sequence information in the target data packet includes sequence information in a second protocol packet header and/or sequence information in a second protocol payload, and the second protocol includes one of the following:

Real-time Transport Protocol (RTP), Secure Real-time Transport Protocol (SRTP), Transmission Control Protocol (TCP), User Datagram Protocol (UDP), Hypertext Transfer Protocol (HTTP), H.26x protocol, Moving Picture Experts Group (MPEG) protocol, Audio Video Coding Standard (AVS) protocol.

In some embodiments, the sequence information includes at least one of:

a second sequence number, a target timestamp, a frame boundary flag, a start packet indicator of the data set, or an end packet indicator of the data set.

In some embodiments, the second sequence number is a sequence number with which data is generated or sent from an application server, and the target timestamp is a timestamp when data is generated or sent from the application server.

In some embodiments, the communication unit 901 is further configured such that, the access network device does not send one or more remaining data packets to the terminal device in a case where the access network device fails to send the target data packet to the terminal device, wherein the one or more remaining data packets are data packets in the data set which are sequenced after the target data packet.

FIG. 10 is a schematic structural diagram of yet another communication apparatus according to an embodiment of the present disclosure, and is applied to a terminal device. As shown in FIG. 10, the communication device 1000 includes a communication unit 1001.

The communication unit 1001 is configured to receive description information of a service data flow and/or sequence number indication information.

The communication unit 1001 is further configured to send the description information of the service data flow and/or the sequence number indication information to the user plane network element. The description information of the service data flow and/or the sequence number indication information are used for the user plane network element to add a first protocol packet header to the target data packet based on the sequence information in the target data packet. The first protocol packet header includes first information readable by an access network device, and the first information indicates a sequence of the target data packet in a data set to which the target data packet belongs.

In some embodiments, the communication apparatus 1000 further includes a processing unit configured to determine a user plane network element.

In some embodiments, the description information includes at least one of packet header information, an application identifier, or a service identifier.

The packet header information includes at least one of a source IP address, a destination IP address, a source port, a destination port, a source MAC address, or a destination MAC address.

In some embodiments, the sequence number indication information comprises at least one of:
explicit indication information and/or implicit indication information, indicating whether to add the first information to the first protocol packet header;
second protocol indication information, including one of: Real-time Transport Protocol (RTP), Transmission Control Protocol (TCP), User Datagram Protocol (UDP), Hypertext Transfer Protocol (HTTP), H.26x protocol, Moving Picture Experts Group (MPEG) protocol, or Audio Video Coding Standard (AVS) protocol;
second information indicating performing data set-level processing on the service data flow;
third information indicating a position for reading the sequence information in the target data packet; or
fourth information indicating that the data set is in frames, or indicating that the data set is in Network Abstraction Layer (NAL) units.

In some embodiments, the position includes at least one of a RTP header, a RTP payload header, or a RTP extension header.

Those skilled in the art should understand that the related description of the above-described communication device according to the embodiment of the present disclosure can be understood with reference to the related description of the communication method according to the embodiment of the present disclosure.

FIG. 11 is a schematic structural diagram of a communication device according to an embodiment of the present disclosure. The communication device 1100 may include one of a user plane network element, an access network device, or a control plane network element. The communication device 1100 illustrated in FIG. 11 may include a processor 1110 and a memory 1120. The memory 1120 stores a computer program executable by the processor 1110, and the processor 1110 implements the communication method in any of the above-described embodiments when executing the program.

In some embodiments, the memory 1120 may be a separate device independent of the processor 1110, or may be integrated in the processor 1110.

In some embodiments, as shown in FIG. 11, the communication device 1100 may further include a transceiver 1130, and the processor 1110 may control the transceiver 1130 to communicate with other devices, specifically, may send information or data to or receive information or data sent by other devices.

Here, the transceiver 1130 may include a transmitter and a receiver. The transceiver 1130 may further include an antenna(s), and the number of antenna(s) may be one or more.

In some embodiments, the communication device 1100 may specifically be a user plane network element, an access network device, or a control plane network element of the embodiment of the present disclosure, and the communication device 1100 may implement corresponding processes implemented by the user plane network element, the access network device, or the control plane network element in each method of the embodiment of the present disclosure, which will not be repeated here for the sake of brevity.

Embodiments of the present disclosure also provide a computer storage medium. One or more programs are stored in the computer storage medium, and the one or more programs can be executed by one or more processors to implement the communication method in any embodiment of the present disclosure.

In some embodiments, the computer-readable storage medium can be applied to the user plane network element, the access network device, or the control plane network element in the embodiments of the present disclosure, and the computer program causes the computer to execute corresponding processes implemented by the user plane network element, the access network device, or the control plane network element in each method of the embodiments of the present disclosure, which will not be repeated herein for the sake of brevity.

FIG. 12 is a schematic structural diagram of a chip according to an embodiment of the present disclosure. The chip 1200 shown in FIG. 12 includes a processor 1210 for calling and running a computer program from a memory to implement the method in any embodiment of the present disclosure.

In some embodiments, as shown in FIG. 12, the chip 1200 may further include a memory 1220. The processor 1210 may call and run a computer program from the memory 1220 to implement the method in the embodiment of the present disclosure.

The memory 1220 may be a separate device independent of the processor 1210 or may be integrated in the processor 1210.

In some embodiments, the chip 1200 may further include an input interface 1230. The processor 1210 may control the input interface 1230 to communicate with other devices or chips, specifically, may acquire information or data sent by other devices or chips.

In some embodiments, the chip 1200 may further include an output interface 1240. The processor 1210 may control the output interface 1240 to communicate with other devices or chips, specifically, may output information or data to other devices or chips.

In some embodiments, the chip can be applied to the user plane network element, the access network device, or the control plane network element in the embodiments of the present disclosure, and the chip can implement corresponding processes implemented by the user plane network element, the access network device, or the control plane network element in each method of the embodiments of the present disclosure, and will not be repeated here for the sake of brevity.

It should be understood that the chip mentioned in the embodiments of this application may also be referred to as a system-on-chip (SoC), system chip, chip system, or on-chip system chip, etc.

Embodiments of the present disclosure also provide a computer program product comprising a computer storage medium storing a computer program comprising instructions executable by at least one processor. The instructions, when executed by the at least one processor, implement the communication method in any embodiment of the present disclosure.

In some embodiments, the computer program product can be applied to the user plane network element, the access network device, or the control plane network element in the embodiments of the present disclosure, and the computer program instructions cause the computer to execute corresponding processes implemented by the user plane network element, the access network device, or the control plane network element in each method of the embodiments of the present disclosure, which will not be described herein for the sake of brevity.

In some embodiments, the computer program product in the embodiment of the present disclosure may also be referred to as a software product in other embodiments.

An embodiment of the present disclosure further provides a computer program that causes a computer to execute the communication method in any one of the embodiments of the present disclosure.

In some embodiments, the computer program can be applied to the user plane network element, the access network device, or the control plane network element in the embodiments of the present disclosure, and the computer program, when running on the computer, causes the computer to execute corresponding processes implemented by the user plane network element, the access network device, or the control plane network element in each method of the embodiments of the present disclosure, which will not be described herein for the sake of brevity.

The processor, communication device or chip according to the embodiment of the present disclosure may be an integrated circuit chip having signal processing capabilities. In the implementation process, the steps of the above-described method embodiments may be completed by integrated logic circuits of hardware in the processor or instructions in the form of software. The processor, communication device, or chip described above may include an integration of any one or more of a general purpose processor, an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a Graphics Processing Unit (GPU), Embedded neural network processors (NPUs), controllers, microcontrollers, microprocessors, programmable logic devices, discrete gate or transistor logic devices, discrete hardware components. The methods, steps, and logical block diagrams disclosed in the embodiments of the present disclosure may be implemented or executed. The general purpose processor may be a microprocessor or the processor may be any conventional processor or the like. The steps of the method disclosed in connection with the embodiments of the present disclosure may be directly embodied as execution by the hardware decoding processor, or may be executed by combining hardware and software modules in the decoding processor. The software module may be located in a storage medium mature in the art such as random memory, flash memory, read-only memory, programmable read-only memory, electrically erasable programmable memory, registers, etc. The storage medium is located in the memory, and the processor reads the information in the memory, and combines its hardware to complete the steps of the above method.

It is understood that the memory or computer storage medium in the embodiments of the present disclosure may be a volatile memory or a non-volatile memory, or may include both volatile and non-volatile memory. The nonvolatile memory may be a Read-Only Memory (ROM), a Programmable ROM (PROM), an erasable programmable Read-Only Memory (EPROM), an electrically erasable programmable Read-Only Memory (EEPROM), or a flash memory. The volatile memory may be a Random Access Memory (RAM), which serves as an external cache. By way of illustration, but not by way of limitation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DR RAM). It should be noted that the memory of the systems and methods described herein is intended to include, but is not limited to, these and any other suitable type of memory.

It should be understood that the above-described memory or computer storage medium is an illustrative but not limiting illustration, for example, the memory in the embodiments of the present disclosure may also be a static random access memory (SRAM), a dynamic random access memory (DRAM), a synchronous dynamic random access memory (SDRAM), a double data rate synchronous dynamic random access memory (DDRAM), an enhanced SDRAM (ESDRAM), a synch link dynamic random access memory (SLDRAM), a Direct Rambus RAM (DR RAM), and the like. That is, the memory in the embodiments of the present disclosure is intended to include, but is not limited to, these and any other suitable type of memory.

Those of ordinary skill in the art will appreciate that the elements and algorithmic steps of the various examples described in connection with the embodiments disclosed herein can be implemented in electronic hardware, or a combination of computer software and electronic hardware. Whether these functions are performed in hardware or software depends on the specific application and design constraints of the technical solution. Those skilled in the art may use different methods for implementing the described functions for each particular application, but such implementations should not be considered beyond the scope of the present disclosure.

Those skilled in the art can clearly understand that for convenience and conciseness of the description, the specific working processes of the systems, devices, and units described above may refer to the corresponding processes in the aforementioned method embodiments, and will not be repeatedly described herein.

In several embodiments provided herein, it should be understood that the disclosed systems, apparatuses, and methods may be implemented in other ways. For example, the device embodiments described above are merely schematic, for example, the division of units is only one logical function division, and there may be other division methods in actual implementation, for example, multiple units or components may be combined or integrated into another system, or some features may be ignored or not implemented. In addition, the coupling or direct coupling or communication connection between each other shown or discussed may be an indirect coupling or communication connection through some interface, device or unit, which may be electrical, mechanical or otherwise.

The units described as separate units may or may not be physically separate, and the units displayed as units may or may not be physical units, that is, they may be located in one place or may be distributed over a plurality of network units. Some or all of the units may be selected according to actual needs to achieve the purpose of the solution of the present embodiment.

In addition, each functional unit in each embodiment of the present disclosure may be integrated in one processing unit, each unit may be physically present alone, or two or more units may be integrated in one unit.

The functions may be stored in a computer-readable storage medium if implemented in the form of software functional units and sold or used as independent products. Based on this understanding, the technical solution of the present disclosure essentially or a part that contributes to the prior art or a part of the technical solution may be embodied in the form of a software product, which is stored in a storage medium and includes several instructions for causing a computer device (which may be a personal computer, a server, or a network device, etc.) to perform all or part of the steps of the method described in various embodiments of the present disclosure. The storage medium includes a USB disk, a removable hard disk, a Read-Only Memory (ROM), a Random Access Memory (RAM), a magnetic disk, or an optical disk that can store a program code.

The above is merely a specific embodiment of the present disclosure, but the scope of protection of the present disclosure is not limited thereto, and any person skilled in the art can easily think of changes or substitutions within the technical scope disclosed in the present disclosure, and should be covered within the scope of protection of the present disclosure. Therefore, the scope of protection of the present disclosure should be subject to the scope of protection of the claims.

1. A communication method, comprising:
adding, by a user plane network element, a first protocol packet header to a target data packet based on sequence information in the target data packet, wherein the first protocol packet header comprises first information readable by an access network device; and
sending, by the user plane network element, the target data packet with the added first protocol packet header to the access network device.

2. The method of claim 1, wherein adding the first protocol packet header to the target data packet comprises:
adding a General Packet Radio Service (GPRS) Tunneling Protocol-User Plane (GTP-U) header to the target data packet.

3. (canceled)

4. The method of claim 1, wherein the sequence information in the target data packet comprises: sequence information in a second protocol packet header and/or sequence information in a second protocol payload, and the second protocol comprises one of the following:
Real-time Transport Protocol (RTP), Secure Real-time Transport Protocol (SRTP), Transmission Control Protocol (TCP), User Datagram Protocol (UDP), Hypertext Transfer Protocol (HTTP), H.26x protocol, Moving Picture Experts Group (MPEG) protocol, Audio Video Coding Standard (AVS) protocol.

5. (canceled)

6. The method of claim 1, further comprising:
receiving, by the user plane network element, description information of a service data flow and/or sequence number indication information sent by a control plane network element; and
reading, by the user plane network element, the sequence information in the target data packet based on the description information of the service data flow and/or the sequence number indication information.

7. The method of claim 6, wherein the description information comprises at least one of header information, an application identifier, or a service identifier; and
wherein the header information comprises at least one of a source Internet Protocol (IP) address, a destination IP address, a source port, a destination port, a source Media Access Control (MAC) address, or a target MAC address.

8. The method of claim 6, wherein the sequence number indication information comprises at least one of the following:
explicit indication information and/or implicit indication information, wherein the explicit indication information and/or the implicit indication information indicate whether to add the first information to the first protocol packet header;
second protocol indication information, wherein the second protocol comprises one of: RTP, TCP, UDP, HTTP, H.26x protocol, MPEG protocol, or AVS protocol;
second information indicating performing data set-level processing on the service data flow;
third information indicating a position for reading the sequence information in the target data packet; or
fourth information indicating that the data set is in frames, or indicating that the data set is in Network Abstraction Layer (NAL) units.

9. (canceled)

10. The method of claim 1, further comprising:
in a case where the position for reading the sequence information in the target data packet is an RTP header, or the data set is in frames, determining, by the user plane network element, the sequence of the target data packet in the data set to which the target data packet belongs, based on at least one of: a target timestamp, a frame boundary flag, or a second sequence number; or
in a case where the position for reading the sequence information in the target data packet is an RTP payload header, or the data set is in NAL units, determining, by the user plane network element, the sequence of the target data packet in the data set to which the target data packet belongs based on at least one of a start packet indicator of the data set, an end packet indicator of the data set, or a second sequence number.

11. (canceled)

12. The method of claim 10, wherein the second sequence number is a sequence number with which data is generated or sent from an application server, and the target timestamp is a timestamp when data is generated or sent from the application server.

13-23. (canceled)

24. A user plane network element, comprising:
a processor; and
a memory storing a computer program executable by the processor, and
wherein the processor, when executing the program, is configured to:
add a first protocol packet header to a target data packet based on sequence information in the target data packet, wherein the first protocol packet header comprises first information readable by an access network device; and
send the target data packet with the added first protocol packet header to the access network device.

25. An access network device, comprising:
a processor; and
a memory storing a computer program executable by the processor, and
wherein the processor, when executing the program, is configured to:
receive a target data packet sent by a user plane network element, wherein a first protocol packet header of the target data packet comprises first information; and
read the first information from the first protocol packet header in the target data packet.

26-31. (canceled)

32. The method of claim 1, wherein the sequence information in the target data packet is read based on descrption information of a service data flow and/or sequence number indication information.

33. The user plane network element of claim 24, wherein the sequence information in the target data packet is read based on descrption information of a service data flow and/or sequence number indication information.

34. The user plane network element of claim 24, wherein in adding the first protocol packet header to the target data packet, the processor is configured to:
add a General Packet Radio Service (GPRS) Tunneling Protocol-User Plane (GTP-U) header to the target data packet.

35. The user plane network element of claim 24, wherein the sequence information in the target data packet comprises: sequence information in a second protocol packet header and/or sequence information in a second protocol payload, and the second protocol comprises one of the following:
Real-time Transport Protocol (RTP), Secure Real-time Transport Protocol (SRTP), Transmission Control Protocol (TCP), User Datagram Protocol (UDP), Hypertext Transfer Protocol (HTTP), H.26x protocol, Moving Picture Experts Group (MPEG) protocol, Audio Video Coding Standard (AVS) protocol.

36. The user plane network element of claim 24, wherein the processor is further configured to:
receive description information of a service data flow and/or sequence number indication information sent by a control plane network element; and
read the sequence information in the target data packet based on the description information of the service data flow and/or the sequence number indication information.

37. The user plane network element of claim 36, wherein the description information comprises at least one of header information, an application identifier, or a service identifier; and
wherein the header information comprises at least one of a source Internet Protocol (IP) address, a destination IP address, a source port, a destination port, a source Media Access Control (MAC) address, or a target MAC address.

38. The user plane network element of claim 36, wherein the sequence number indication information comprises at least one of the following:
explicit indication information and/or implicit indication information, wherein the explicit indication information and/or the implicit indication information indicate whether to add the first information to the first protocol packet header;
second protocol indication information, wherein the second protocol comprises one of: RTP, TCP, UDP, HTTP, H.26x protocol, MPEG protocol, or AVS protocol;
second information indicating performing data set-level processing on the service data flow;
third information indicating a position for reading the sequence information in the target data packet; or
fourth information indicating that the data set is in frames, or indicating that the data set is in Network Abstraction Layer (NAL) units.

39. The user plane network element of claim 24, the processor is further configured to:
in a case where the position for reading the sequence information in the target data packet is an RTP header, or the data set is in frames, determine the sequence of the target data packet in the data set to which the target data packet belongs, based on at least one of: a target timestamp, a frame boundary flag, or a second sequence number; or
in a case where the position for reading the sequence information in the target data packet is an RTP payload header, or the data set is in NAL units, determine the sequence of the target data packet in the data set to which the target data packet belongs based on at least one of: a start packet indicator of the data set, an end packet indicator of the data set, or a second sequence number.

40. The access network device of claim 25, wherein in reading the first information from the first protocol packet header in the target data packet, the processor is configured to:
read the first information from a General Packet Radio Service (GPRS) Tunneling Protocol-User Plane (GTP-U) header in the target data packet.

41. The access network device of claim 25, wherein the sequence information in the target data packet comprises: sequence information in a second protocol packet header and/or sequence information in a second protocol payload, and the second protocol comprises one of the following:
Real-time Transport Protocol (RTP), Secure Real-time Transport Protocol (SRTP), Transmission Control Protocol (TCP), User Datagram Protocol (UDP), Hypertext Transfer Protocol (HTTP), H.26x protocol, Moving Picture Experts Group (MPEG) protocol, Audio Video Coding Standard (AVS) protocol.
